(19) United States
(12) Patent Application Publication
(10) Pub. No.: US 2009/0005966 A1
(43) Pub. Date: Jan. 1, 2009

(54) System and method for enhanced directory assistance features employing telematics and virtual reality elements

(76) Inventors: Faith McGray, Bethlehem, PA (US); Alexis Tabora Adorable, Bislig (PH); Jade Turla Yabot, Marilao (PH); Christian Paolo Pestelos, Caloocan City (PH)

Correspondence Address: SOFER & HAROUN LLP., 317 MADISON AVENUE, SUITE 910, NEW YORK, NY, 10017, US

(21) Appl. No.: 12/157,926

(22) Filed: Jun. 13, 2008

Related U.S. Application Data
(60) Provisional application No. 60/936,008, filed on Jun. 15, 2007.
(60) Provisional application No. 60/936,168, filed on Jun. 18, 2007.
(60) Provisional application No. 60/936,717, filed on Jun. 21, 2007.
(60) Provisional application No. 61/066,461, filed on Feb. 20, 2008.
(60) Provisional application No. 61/125,274, filed on Apr. 23, 2008.

(51) Int. Cl. G01C 21/00; G06Q 30/00

(52) U.S. Cl. 701/201; 705/14

(57) ABSTRACT

A method for providing information to a user includes receiving a communication signal from a user requesting at least one information, retrieving the information and delivering it to the user, where the information is configured to be displayed on a telematic display.

### RELATED APPLICATIONS

This application claims the benefit of priority from U.S. Provisional Patent Application Nos.: 60/936,008 filed on Jun. 15, 2007; 60/936,168 filed on Jun. 18, 2007; 60/936,717 filed on Jun. 21, 2007; 61/066,461 filed on Feb. 20, 2008; and 61/125,274 filed on Apr. 23, 2008, the entirety of which are incorporated herein by reference.

### FIELD OF THE INVENTION

This application relates to enhanced directory assistance services. More particularly, the application relates to enhanced directory assistance systems employing improved interface technologies.

### BACKGROUND

Directory assistance services have been known for some time, allowing a first requester to seek the telephone number of a desired party. Recently, the rapid advancements in communications devices, particularly mobile communication devices, has allowed directory assistance and operator platform services to greatly expand available services to include seeking electronic contact information for desired parties, receiving directions, performing concierge services, etc. . . .

However, although the processing power of mobile devices has greatly increased in order to support such connectivity services, the size of portable communication devices remains relatively small.

### OBJECTS AND SUMMARY

The present invention looks to overcome the drawbacks associated with the prior art and to provide an improved interface for communicating to and receiving information from a directory assistance and operator services platform.

To this end, the present invention provides for a method for providing information to a user including receiving a communication signal from a user requesting at least one information, retrieving the information and delivering the information to the user, where the information is configured to be displayed on a telematic display.

### BRIEF DESCRIPTION OF THE DRAWINGS

The present invention can be best understood through the following description and accompanying drawings, wherein:

FIG. 1 illustrates an enhanced directory assistance system in accordance with one embodiment of the present invention;

FIG. 2 illustrates an exemplary telematic equipped environment coupled to the enhanced directory assistance system from FIG. 1, in accordance with one embodiment of the present invention;

FIG. 3 is a flow chart showing the steps of performing directory assistance through the telematic equipment of FIG. 2 and the directory assistance system of FIG. 1, in accordance with one embodiment of the present invention;

FIG. 3A is a display screen shot of the results of the flow chart from FIG. 3, in accordance with one embodiment of the present invention;

FIG. 4 is another flow chart showing the steps of performing directory assistance through the telematic equipment of FIG. 2 and the directory assistance system of FIG. 1, in accordance with one embodiment of the present invention;

FIG. 4A is a display screen shot of the results of the flow chart from FIG. 4, in accordance with one embodiment of the present invention;

FIG. 5 is a flow chart showing the steps of performing gaming activities through the telematic equipment of FIG. 2 and the directory assistance system of FIG. 1, in accordance with one embodiment of the present invention;

FIG. 5A is a display screen shot of the results of the flow chart from FIG. 5, in accordance with one embodiment of the present invention;

FIG. 5B is another display screen shot of the results of the flow chart from FIG. 5, in accordance with one embodiment of the present invention;

FIG. 6 is a flow chart showing the steps of performing gaming services through the telematic equipment of FIG. 2 and the directory assistance system of FIG. 1, in accordance with one embodiment of the present invention; and

FIG. 7 is a flow chart showing the steps of performing emergency services through the telematic equipment of FIG. 2 and the directory assistance system of FIG. 1, in accordance with one embodiment of the present invention.

### DETAILED DESCRIPTION

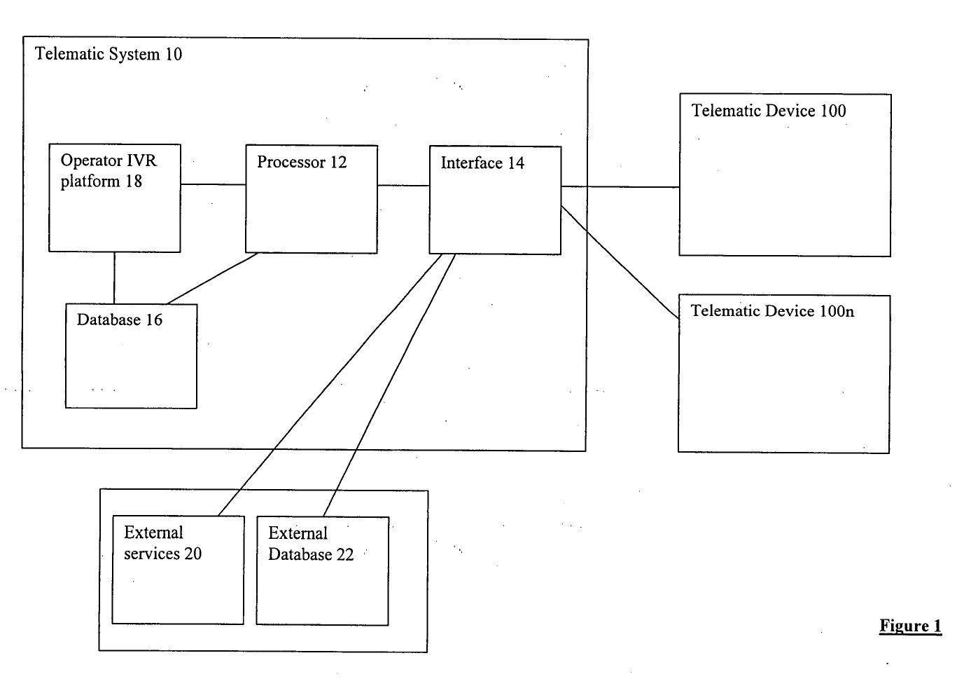

In one embodiment of the present invention, as illustrated in FIG. 1, an enhanced directory assistance system 10 is shown for supporting various operator assisted services, concierge services, game services and other safety services. System 10 employs a processor module 12, a communications interface 14, a database 16 and a directory assistance/operator services platform 18. System 10 may further advantageously be coupled to third party external services 20 and third party data sources 22.

Processor 12 is preferably one or more processors, such as server processors, data processors, graphics processors etc. . . . , in an arrangement for carrying out the various functions of system 10, the details of which are set forth in detail below.

Interface 14 is preferably an incoming and outgoing communication module, such as mobile phone switching equipment, internet gateway equipment, etc. . . . , that is cable of communication with a plurality of system 10 users via wire lines, wireless or internet based communication channels. Interface 14 is coupled with processor 12 as well as external services 20 and data sources 22.

Database 16 is preferably one or more databases coupled to processor 12 for storing the necessary data for carrying out the operations of system 10 as set forth in more detail below. Such operations may include, but are not limited to, storing listing information, directions/geocoding information, profile information for system 10 users, user histories, third party data for performing retail and concierge services for users etc. . . . Although database 16 is shown within system 10, it is understood that database 16 may be operated by a third party, and may be remotely located.

Directory Assistance and operator services platform 18 is configured to provide automated IVR (Interactive Voice Response) and live operator support for facilitating the services offered by system 10. Operator services platform 18 provides the interaction capabilities to users, coupled to system 10 though interface 14, so that their requests may be parsed and handled via processor 12. The details of the various services are outlined below. It is understood that for each service offered by system 10, operator services platform 18 may conduct the necessary interactions either by live operator, automated format, or some combination of the two.

Third party external services 20 may be any number of externally provided services including but not limited to traffic/directions/mapping information, emergency services (9-1-1, 3-1-1, etc. . . . ), gaming providers, advertisement providers and retail providers. As described below, system 10, during sessions with a user of system 10, and when otherwise necessary, may interact with external services 20 to offer, supplement or complete transactions. Similarly, third party external data sources 22 may be any number of externally provided data repositories that are used for offering, supplementing or completing transactions for services offered to users of system 10 as discussed in detail below.

System 10 as shown in FIG. 1 and as described above is an exemplary arrangement. It is understood that the components described above and the arrangement of such components from FIG. 1 may be combined or subdivided into sub-modules as desired and as required to meet processing needs. Furthermore, although system 10 is shown as a single system, it is understood that the system 10 may be a distributed network of various systems 10, each of which is distributed geographically in order to meet communications, and processing needs.

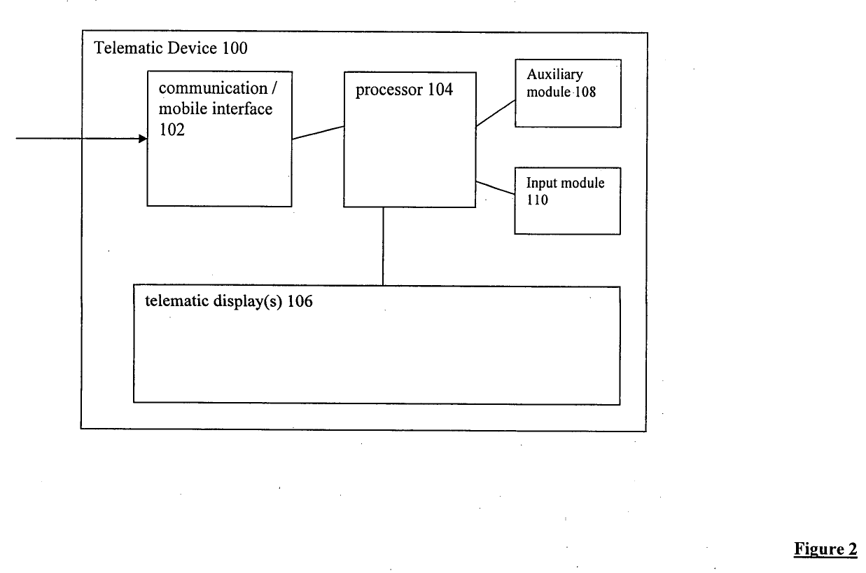

In one arrangement of the present invention as shown in FIGS. 1 and 2, one or more telematic devices 100 are each configured to be in communication with system 10 via a wireless communication interface module 102.

As shown in FIG. 2, telematic device 100 includes a communication interface 102, a processor 104 and at least one telematic display 106. Communication interface 102 is advantageously a wireless communication device such as a cellular or Wi-Fi/WiMax device that is either a permanent component of device 100 or may be a portable device such as the mobile telephone (or personal communication device) of the user that is connected to and/or installed into telematic device 100 during use. For example, in a typical arrangement, it is contemplated that the primary communication interface 102 for device 100 is the mobile communication device of a user which connects, either by wireline or wireless (wi-fi, Bluetooth, etc. . . . ) connection, to processor 104. In this instance any data or communications sent to device 100 from system 10 may be easily stored in the communication interface 102 so that it may be easily removed and taken by the user when the user exits device 100.

Processor 104 is preferably a processor for interpreting incoming communications from system 10 and displaying graphics onto display 106, and to further receive input from the user through display 106 and send return communications to system 10.

Telematic display 106 of device 100 is at least one screen or visual display that is visible to a user and includes the ability for a user to enter commands by touch. The present invention contemplates that the telematic display 106 is at least partly a function of telematic device 100.

For example, in a first arrangement, telematic device 100 may be a user's car. In such an arrangement as noted above communication interface 102 may be a user's cellular phone. Telematic display 106 in this case may be one or more windows within the vehicle that are outfitted with the ability to have images projected/displayed thereon and with the ability to receive inputted tactile (touch screen) commands from a user. In another arrangement, the telematic displays may be thin film displays that are rolled onto or adhered to the windows or other surfaces of the car. Such displays 106 may be transparent or semi-transparent.

In an alternative arrangement, telematic device 100 may be a fixed gaming environment, such as a 3-D virtual gaming cube. Here communication interface 102 may be a fixed internet connection or a high speed wireless, mobile connection and processor 104 includes a high speed graphics processor 104. Telematics display 106 in this case can be one or more of the walls of the gaming cube.

For the purposes of illustrating the salient features of the present invention, the below described services offered by system 10 to a user of a telematic device 100 are discussed in the context of device 100 being an automobile. However, it is understood that any of the below described features may be employed on any fixed or mobile telematic device 100 such as gaming systems, television/monitors, home/office windows, etc. . . .

In another embodiment of the present invention, as illustrated in FIG. 2, in addition to telematic display 106, telematic device 100 may employ one or more auxiliary environment components 108 for providing secondary interaction with the users of device 100. For example, auxiliary components may include, but are not limited to speakers, vibrating panels/mats/controls, fans, tactile feedback devices etc. . . . , each of which may be configured to augment images on telematic display 106 during certain functions such as gaming and/or functional image displays. For example, an advertisement on telematic display 106 for an airline vacation to a breezy island may include signals to processor 104 to have a fan blow air over a user during the display of an image of an island/beech resort.

In another embodiment of the present invention as illustrated in FIG. 2, an input module 110 is also coupled to processor 104 of device 100 for receiving input in various forms (apart from the telematic display 106). Such input module 110 may include the ability to read remote transmitters, RFID (Radio Frequency Identification Devices), cameras directed both inboard and outboard of a vehicle, infra/red or heat sensors directed inboard of a vehicle, microphones for receiving voice inputs, MicroElectroMechanical Systems (MEMS) & BioMEMS interfaces and other such input means necessary for carrying out the various services of system 10 as outlined in detail below.

Telematic device 100 as shown in FIGS. 1 and 2 and as described above is an exemplary discussion of its components. It is understood that the components described above and the arrangement of such components from FIGS. 1 and 2 may be combined or subdivided into sub-modules as desired and as required to meet processing needs.

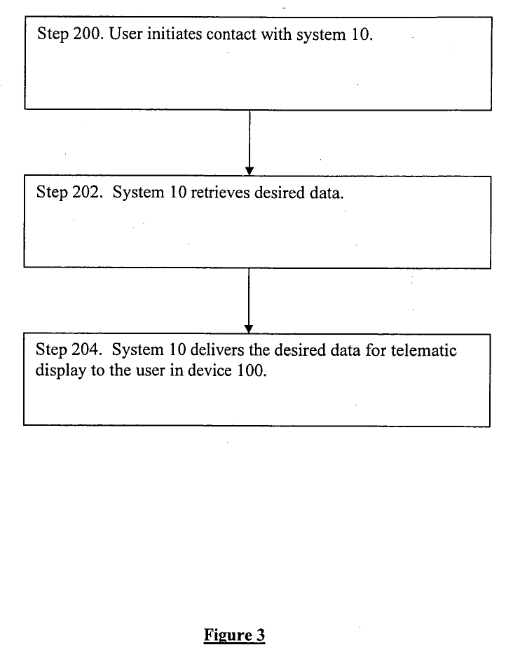

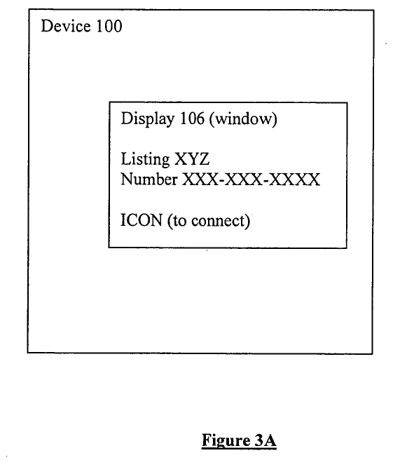

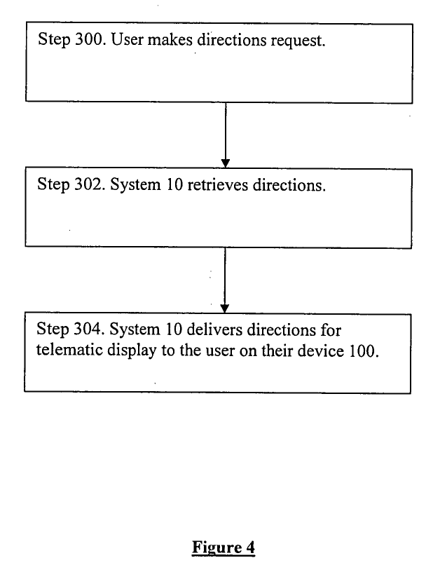

Turning now to the various services offered by system 10 to users of a telematic device 100, FIG. 3 illustrates a flowchart showing an exemplary directory assistance request conducted through telematic display 106.

At a first step 200, a user of telematic device 100, after coupling their wireless device (communication interface 102) to their vehicle, initiates a communication to system 10 using either a voice command or a telematic entry on display 106. It is contemplated that a user may have small icon on their display 106 (such as the driver side window) that allows them to initiate a one touch connect with an operator at system 10.

At step 202, an IVR or operator at system 10 receives a directory assistance request from the user. For example, a user may ask for the contact information of a local hardware store. At step 204, after retrieving the contact data from database 16 forwards the data to the user. This data may be advantageously displayed to the user on display 106 and possibly stored in their mobile device which is being used as communication device 102. The electronic format for these two-way communications, as well as any other two-way communications between system 10 and device 100 described through the application, may be in any available electronic format including but not limited to SMS, HTTP, WAP, e-mail or any other advancement or modification to such formats.

In one arrangement, telematic display 106, may not only include the requested data, but also may include a link for automatic call completion to the contact as shown in the exemplary telematic display 106 screen shot of FIG. 3A. Such an arrangement allows the user to utilize a high visible telematic display 106, such as a display on the window of their car, that allows them to view and connect to a desired directory assistance listing, without having to view a small screen, such as console monitor or a mobile device screen which would require their looking away from the road.

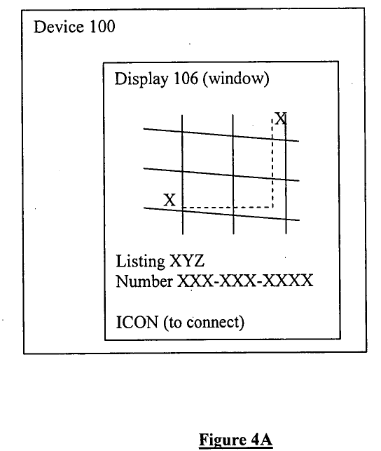

FIG. 4 illustrates a second directory assistance flowchart showing an exemplary directory assistance directions request conducted through telematic display 106.

At a first step 300, a user of telematic device 100 initiates a communication to system 10 using either a voice command or a telematic entry on display 106. It is contemplated that a user may have second icon on their display 106 (such as the driver side window) that allows them to initiate a one touch connect for obtaining directions with system 10. Such a service may be easily coupled with the above described contact listing directory assistance process.

At step 302, an IVR or operator at system 10 receives a directory assistance request from the user. For example, a user may ask for directions to a local hardware store. At step 304, after retrieving the directions data from database 16 or external database 22 forwards the mapping data to the user.

Such mapping data may be advantageously displayed to the user on display 106 and possibly stored in their mobile device which is being used as communication device 102, as shown in the exemplary telematic display 106 screen shot of FIG. 4A. A drag and drop feature may allow the user to move the map from one screen (window) to another screen (windshield) as desired, either by voice command or touch screen operation.

This arrangement allows the user to utilize a high visible telematic display 106, such as a display on the window of their car, that allows them to view mapping and directions information to a desired destination, without having to view a small screen, such as console monitor or a mobile device screen which would require their looking away from the road.

It is contemplated that a number of additional services may be supported by system 10 in conjunction with mapping/directions that are facilitated by telematic display 106. For example, in a first arrangement, system 10 may, in addition to forwarding basic mapping and directions information to the user, may also forward images of landmarks to be displayed to the driver for comparison. Because the images will be displayed directly onto telematic display 106, the user may, without distraction casually review the landmarks or other along-the-route images, to make sure they are properly following the directions.

In another arrangement, device 100 may be coupled to or substitute as an EZ-Pass™ system that uses input/output module 110 to pay any necessary tolls as well as displaying the payment confirmation and amount using telematic display 106.

Yet another additional feature supported by system 10 in combination with directions features is the ability to provide telematic displays of advertisements for commercial institutions located along the provided routes. By popping the advertisement to telematic display 106 along with the directions, a user may easily touch telematic display 106 or issue a voice command so that advertisement is fully read to user 10 or even stored to their connected personal communication device. Such advertisements may include coupons or other such incentives to stop along the route.

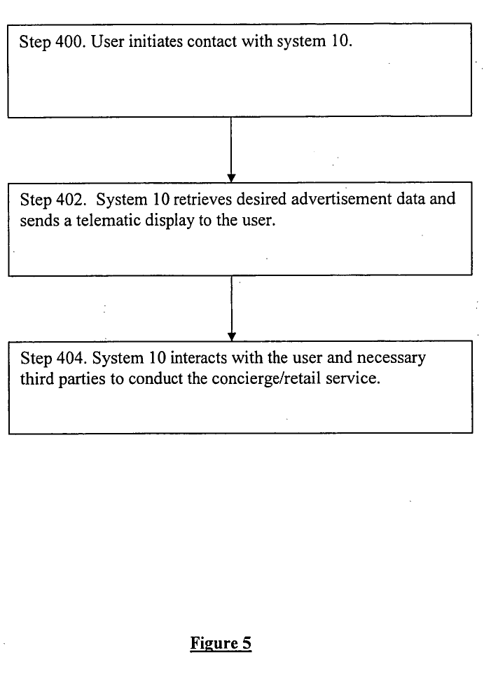

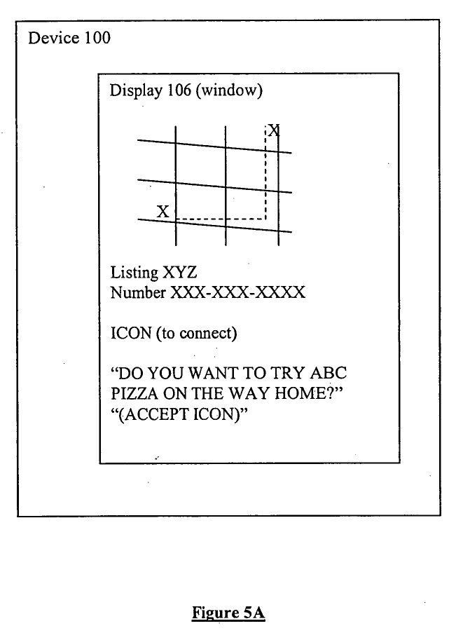

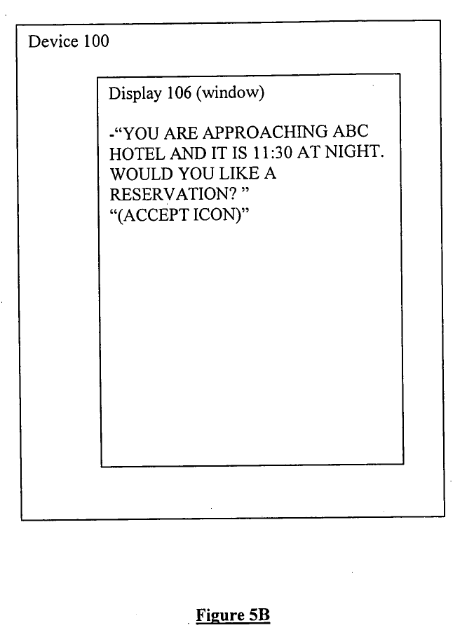

FIG. 5 illustrates a third directory assistance flowchart showing an exemplary directory assistance retail/concierge request conducted through telematic display 106.

At a first step 400, a user of telematic device 100 initiates a communication to system 10 using either a voice command or a telematic entry on display 106. It is contemplated that a user may have a third icon on their display 106 that allows them to initiate a one touch connect for conducting a retail purchase or other retail service with system 10. Such a service may be easily coupled with the above described directions or contact listing directory assistance processes. At step 402, an IVR or operator at system 10 receives a concierge request from the user. For example, a user may ask to purchase an item from an advertisement displayed on their telematic display 106 or they may be requesting concierge services such as reservations at a restaurant. At step 404, after conducting the desired request in conjunction with any necessary external services platforms 20, a confirmation is forwarded to the user.

In first exemplary arrangement of a retail operation, a user may be driving and request directions as noted above. An advertisement, located along the route may be for a product, which the user desires to purchase. This advertisement may be pushed to their telematic display 106 for easy viewing. The user may simply touch the advertisement (at a location that indicates accept) or make a verbal request to complete the transaction. For example, a user on their way out for a trip to a local hardware store may receive an advertisement for a local pizza restaurant. By activating the advertisement the user may pre-order a pizza for pick-up on the way home. The advertisement may include a possible e-coupon delivered to their mobile device for redemption at pick up of the pizza. FIG. 5A is an exemplary telematic display of a retail advertisement on telematic display 106.

In another example, a user may be traveling to an airport to which they have asked directions. Here a service to have pre-check-in with seat assignment may be offered through a connection with system 10 and external services 20 to make advance seat assignment selections using telematic display 106.

In yet another example of a commercial or retail transaction conducted through telematic display 106, it is contemplated that at any time, a user passing an “active” billboard may receive a signal at input module 110 of telematic device 100 that triggers an advertisement to be displayed to the user on their telematic display. A user may accept or interact with the advertisement with completion of the transaction handled through system 10 and external services 20 (if necessary). For example, a user passing a billboard for a hotel may receive an advertisement/coupon directly to their telematic display 106. If accepted, system 10, using the information obtained by input module 110 may contact the hotel and complete a concierge reservation for the user and contact them with a receipt.

FIG. 5B is sample view of telematic display 106 with an advertisement populated from an active billboard. Such billboards, with enough wireless range, may even receive communications back from telematic device 100 for data collection (i.e. hit counters, possible “passer-by information, etc. . . . ). It is further noted, that using GPS or other tracking technology, as the vehicle (telematic device 100) passes certain locations, similar interactive telematic advertisements may be displayed to the user, even without the need to specifically pass an active billboard.

A similar arrangement may allow for monitoring stations located along roadways to provide interactive and telematic warnings related to environmental conditions (smog, greenhouse gasses, etc. . . . ) with coupled data collection from devices 100 such as the number and type of cars passing a certain location. The monitoring stations may include fixed transceivers or mobile micro-sized transceivers such as mobile information gathering/transmitting drones.

It is noted that there are many possible variations for displaying telematic advertisements to a user via system 10 and telematic device 100. It is contemplated that any similar advertisements displayed to a user of a telematic device 100 for interaction and completion through a similar system 10 is within the contemplation of the present invention. It is further contemplated that advertisements displayed on telematic display 106 that are visible to others such as to other motorists may have the cost of using some of the services of system 10 offset by such displays.

In one arrangement of the present invention, for each of the above described directory assistance, directions and retail/concierge services described, system 10 may store a user profile within database 16 so as to assist operator platform 18 in completing any necessary actions related to the telematic advertisements. For example, such profiles may include, but are not limited to personal contact lists, preferred (frequently requested) listings, preferred directions, preferred communications formats for receiving maps, contacts (e.g. SMS contact information), commercial information/payment options for retail services etc. . . . )

In another arrangement of the present invention, retail services that employ stored profile commercial payment information may be secured. Password and release by the user may conducted using a combination of ANI or other such wireless identifiers as well as biometric information such as voiceprints, fingerprints and retina scans, supported through telematic device 100 and telematic display 106.

In another embodiment of the present invention, system 10 and telematics device 100 may be used to implement telematic gaming experiences. As noted above, device 100 may be a 3-D gaming cube or other static gaming device. However, regarding the following description of gaming functions, it is contemplated that a user may operate a telematic game at home in a fixed device 100 in a car based device 100, may move a game back and forth between the two, or may operate multiple games (for several children in a car) on display 106.

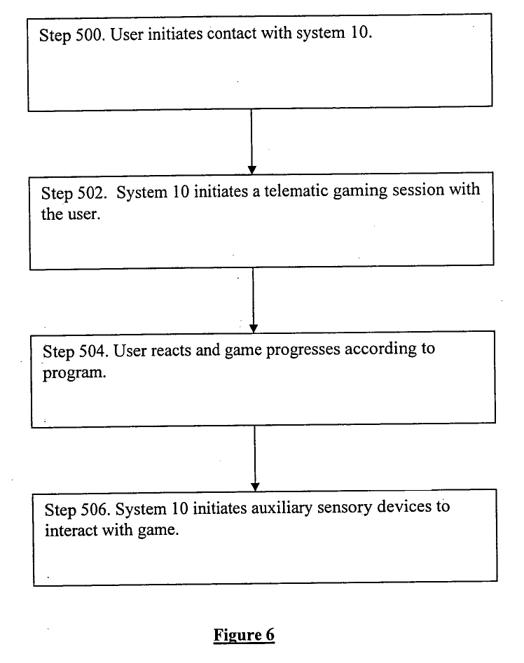

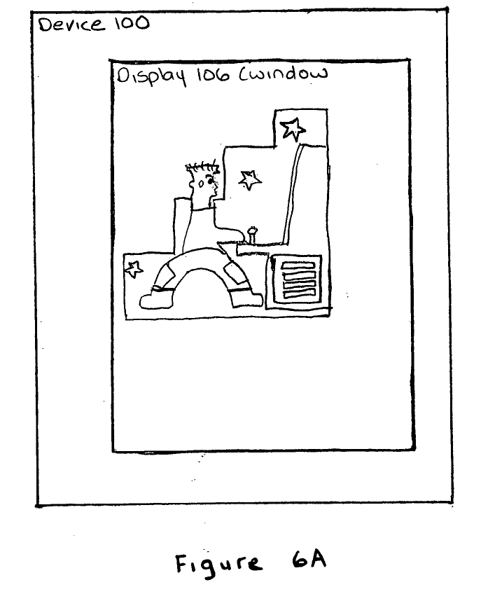

At step 500 as shown in FIG. 6, a user initiates a communication with system 10 through communication module 102 of device 100 to initiate a game action. At step 502, processors 12 and 104 interact to generate a telematic gaming experience which is displayed to the user on their display 106.

At step 504, as the user reacts to the input module 110 and display 106 records the user's movements and the game plays according to its programming. At step 506, game instructions may optionally take advantage of auxiliary module 108 to cause vibrations or air movements in accordance with the game play. FIG. 6A shows an exemplary screen display on telematics display 106.

In another embodiment of the present invention, games played on device 100 may be interactive with a mobile environment. For example, using input camera 110 and GPS, a game may be able to know the location of device 100 (vehicle) and display images based geographically relevant questions to the users, such as to identify local environmental features (what river are we crossing?) with the answers including some relevant educational material. Similar games may identify passing cars for a car enthusiast etc. . . .

In another embodiment of the present invention, the telematic images displayed on display 106 may for the game may include advertisements embedded directly therein. Such advertisements may be activated through voice commands or the telematic display 106 and completed by operator service platform 18 of system 10 as described above.

In another embodiment of the present invention, multi-player telematic games may managed via multiple links to system 10 by various users of devices 100. Similarly, business users may be able to conduct on-the-move group tele-conferences, communications and display being coordinated and system 10.

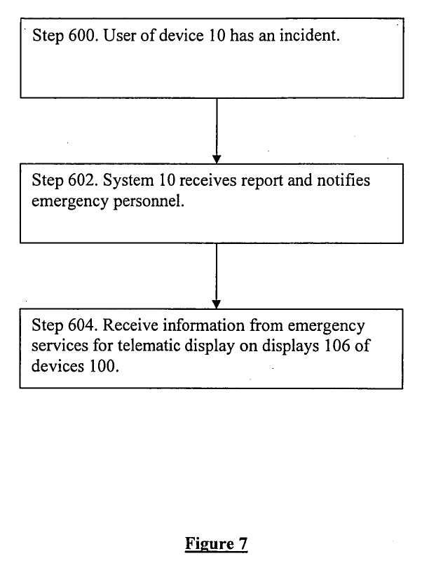

In another embodiment FIG. 7 illustrates a fifth directory assistance flowchart showing an exemplary law enforcement or emergency services use conducted through telematic display 106.

At a first step 600, a user of telematic device 100, such as their motor vehicle, is involved in an incident, such as a traffic accident. Upon detection of an accident using input module 110, a notification communication is sent to system 10.

At step 602, an processor 12 of system 10 receives the emergency communication and immediately forwards the communication to an external service 20, such as an area 9-1-1 service or other such emergency management agency. System 10 may provide personal data from the stored profile as well as location data to the emergency personnel. At step 604, using the connection through system 10, the present invention allows for the advantageous communication of telematic material to the user, such a emergency care instructions or other safety instructions to be displayed through display 106. It is contemplated that, even without incident, periodic alerts may be forwarded to system 10 from emergency services 20 for distribution to devices 100 for telematic display including but not limited to missing persons/Amber alerts, weather alerts, criminal activity alerts etc. . . .

In yet another embodiment of the present invention, system 10 may further monitor telematic device 100 using input module 110 for emergency situations.

In a first example, in the event of child or pet left in a car on a hot day, system 10 may use input sensors from module 110 to detect elevated temperatures (using a thermometer) and auto-detection mechanisms to detect a human or animal (using a motion sensor, microphone/RFID detection (with profile)). If a certain threshold is reached when the car is not moving, an alarm may be sent to a local emergency services station 20 along with the location of the vehicle (device 100). System 10 may also advantageously alert passers-by flashing warnings onto the telematic displays 106 of the vehicle in an attempt to get more urgent attention to the situation.

In another example, input module 110 may be configured to detect individuals by using voice prints, RFID chips or other such methods so that if an unauthorized user enters the car the authorities and the owner may be alerted. The telematic display 106 may engaged to advise the occupant of the situation (so that an errant alert can be detected). Similarly, emergency medical situations or even sleeping drivers may be monitored and alerted using the telematic displays 106 and input module 110. In each case, system 10 may employ a live or IVR operator to assist the user and to coordinate with external services 20 if necessary.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for providing information to a user, said method comprising the steps of:
receiving a communication signal from a user requesting at least one information;
retrieving said information; and
delivering said retrieved information to said user, wherein said information is configured to be displayed on a telematic display.

2. The method as claimed in claim 1, wherein said information is any one of a contact information or directions to a location.

3. The method as claimed in claim 1, wherein directions provided to said user includes a map for telematic display.

4. The method as claimed in claim 3, wherein said display further includes at least one landmark located along a route, an image of said landmark being displayed on said telematic display.

5. The method as claimed in claim 3, wherein said display further includes at least one advertisement located along a route, said advertisement being displayed on said telematic display.

6. A method for providing information to a user, said method comprising the steps of:
receiving a signal from a telematic device of a user including an advertisement notification;
retrieving said advertisement; and
delivering said advertisement to said user, wherein said advertisement is configured to be displayed on a telematic display of said user.

7. The method as claimed in claim 6, wherein said signal is caused by passing an active advertisement sign.

8. The method as claimed in claim 6, wherein said signal is caused by said telematic display being within a particular geographic region.

9. The method as claimed in claim 6, wherein said advertisement is telematically displayed to said user in the context of a telematic video game.

10. The method as claimed in claim 6, wherein said advertisement allows for telematic acceptance in order to complete a commercial transaction.

11. The method as claimed in claim 10, wherein said commercial transaction is completed using a stored profile of the user.

12. The method as claimed in claim 6, wherein said advertisements displayed on said telematic display may provide renumeration to said user.

13. A method for providing information to a user, said method comprising the steps of:
receiving a signal including an indication of an incident;
contacting an emergency service; and
delivering at least on telematic display to said user for assistance with said incident.

14. The method as claimed in claim 13, wherein said signal of said incident is generated by a telematic device of said user.

15. The method as claimed in claim 14, further comprising the step of providing a location of said user to said emergency service.

16. The method as claimed in claim 14, wherein said telematic display provided to said user is an instruction on how to address an emergency.

17. The method as claimed in claim, wherein said signal is from a sensor associated with a telematic device of said user indicating a child or animal in a hot car, wherein said telematic display is a warning to passers-by requesting assistance.

18. The method as claimed in claim 13, wherein said signal of said incident comes from said emergency service.

19. The method as claimed in claim 18, wherein said telematic display is an Amber Alert.

20. The method as claimed in claim 18, wherein said telematic display is a severe weather warning.
